(19) United States
(12) Patent Application Publication
(10) Pub. No.: US 2024/0412385 A1
(43) Pub. Date: Dec. 12, 2024

(54) OBJECT TRACKING PROCESSING DEVICE, OBJECT TRACKING PROCESSING METHOD, AND NON-TRANSITORY COMPUTER READABLE MEDIUM

(71) Applicant: NEC Corporation, Minato-ku, Tokyo (JP)

(72) Inventor: Satoshi Yamazaki, Tokyo (JP)

(73) Assignee: NEC Corporation, Minato-ku, Tokyo (JP)

(21) Appl. No.: 18/697,600

(22) PCT Filed: Oct. 13, 2021
(86) PCT No.: PCT/JP2021/037921

§ 371 Date: Apr. 1, 2024

(51) Int. Cl. G06T 7/246; G06V 10/74; G06V 20/40

(52) U.S. Cl. CPC G06T 7/248; G06V 10/761; G06T 2207/10016; G06V 20/40

(57) ABSTRACT

An object tracking processing apparatus includes: an object grouping processing unit that calculates at least one similar object group including at least one object similar to a tracking target object, on the basis of at least a feature amount of the tracking target object; and an object tracking unit that assigns a tracking ID for identifying an object belonging to the similar object group to the object. As a result, the tracking accuracy of the object appearing in a video can be improved.

### TECHNICAL FIELD

The present disclosure relates to an object tracking processing apparatus, an object tracking processing method, and a non-transitory computer readable medium.

### BACKGROUND ART

For example, Patent Literature 1 discloses a system that detects an object appearing in a video and tracks the same object across frames one after another (multi object tracking (MOT)).

### CITATION LIST

### Patent Literature

Patent Literature 1: International Patent Publication No. WO2021/140966

### SUMMARY OF INVENTION

### Technical Problem

However, in Patent Literature 1, since the same object is determined on the basis of non-spatio-temporal similarity of the object, there is a problem that a tracking result against a constraint is obtained in a spatio-temporal manner, and a tracking accuracy is degraded.

In view of the above-described problems, an object of the present disclosure is to provide an object tracking processing apparatus, an object tracking processing method, and a non-transitory computer readable medium capable of improving the tracking accuracy of an object appearing in a video.

### Solution to Problem

An object tracking processing apparatus according to the present disclosure includes: an object grouping processing unit configured to calculate at least one similar object group including at least one object similar to a tracking target object, on the basis of at least a feature amount of the tracking target object; and an object tracking unit configured to assign a tracking ID for identifying an object belonging to the similar object group to the object.

An object tracking processing method of the present disclosure includes: an object grouping processing step of calculating at least one similar object group including at least one object similar to a tracking target object, on the basis of at least a feature amount of the tracking target object; and an object tracking step of assigning a tracking ID for identifying an object belonging to the similar object group to the object.

Another object tracking processing method of the present disclosure includes: a step of detecting a tracking target object in a frame and a feature amount of the tracking target object each time when the frame configuring a video is input: a step of calculating at least one similar object group including at least one object similar to the tracking target object, on the basis of at least the feature amount of the detected tracking target object, by referring to an object feature amount storage unit: a step of storing, for the detected tracking target object, a position of the object, a detection time of the object, a feature amount of the object, and a group ID for identifying a group to which the object belongs in the object feature amount storage unit: a step of storing, for the detected tracking target object, the position of the object, the detection time of the object, and the group ID for identifying the group to which the object belongs in an object group information storage unit; and a step of executing batch processing of assigning a tracking ID for identifying an object belonging to the similar object group to the object with reference to the object group information storage unit, at predetermined intervals.

A non-transitory computer readable medium of the present disclosure is a non-transitory computer readable medium recording a program for allowing a computer to execute: an object grouping processing step of calculating at least one similar object group including at least one object similar to a tracking target object, on the basis of at least a feature amount of the tracking target object; and an object tracking step of assigning a tracking ID for identifying an object belonging to the similar object group to the object.

### Advantageous Effects of Invention

According to the present disclosure, it is possible to provide the object tracking processing apparatus, the object tracking processing method, and the non-transitory computer readable medium capable of improving the tracking accuracy of the object appearing in the video.

### BRIEF DESCRIPTION OF DRAWINGS

FIG. 1 is a schematic configuration diagram of an object tracking processing apparatus 1.

FIG. 2 is a flowchart of an example of an operation of the object tracking processing apparatus 1.

FIG. 3A is an image diagram of first-stage processing executed by the object tracking processing apparatus 1.

FIG. 3B is an image diagram of second-stage processing executed by the object tracking processing apparatus 1.

FIG. 4 is a block diagram illustrating a configuration of an object tracking processing apparatus 1 according to a second example embodiment.

FIG. 5 is a flowchart of processing of grouping objects detected by an object detection unit 10.

FIG. 6 is an image diagram of the processing of grouping the objects detected by the object detection unit 10.

FIG. 7 is an image diagram of the processing of grouping the objects detected by the object detection unit 10.

FIG. 8 is a diagram illustrating a state in which each of object tracking units 50A to 50C parallelly executes processing of assigning a tracking ID for identifying an object to the object belonging to a similar object group (one similar object group different from each other) associated with each of the object tracking units.

FIG. 9 is a flowchart of the processing of assigning a tracking ID for identifying an object to the object belonging to a similar object group calculated by an object grouping processing unit 20.

FIG. 10 is an image diagram of the processing of assigning the tracking ID for identifying the object to the object belonging to the similar object group calculated by the object grouping processing unit 20.

FIG. 11 is an example of a matrix (a table) used in the processing of assigning the tracking ID for identifying the object to the object belonging to the similar object group calculated by the object grouping processing unit 20.

FIG. 12 is a hardware configuration example of the object tracking processing apparatus 1 (an information processing device).

### EXAMPLE EMBODIMENT

### First Example Embodiment

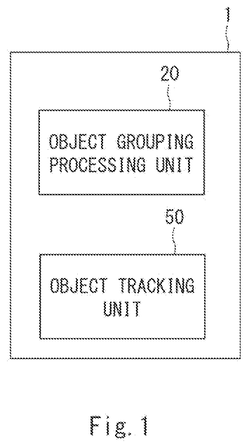

First, a configuration example of an object tracking processing apparatus 1 according to a first example embodiment will be described with reference to FIG. 1.

FIG. 1 is a schematic configuration diagram of the object tracking processing apparatus 1.

As illustrated in FIG. 1, the object tracking processing apparatus 1 includes an object grouping processing unit 20 that calculates at least one similar object group including at least one object similar to a tracking target object, on the basis of at least the feature amount of the tracking target object, and an object tracking unit 50 that assigns a tracking ID to an object belonging to the similar object group.

Next, an example of the operation of the object tracking processing apparatus 1 will be described.

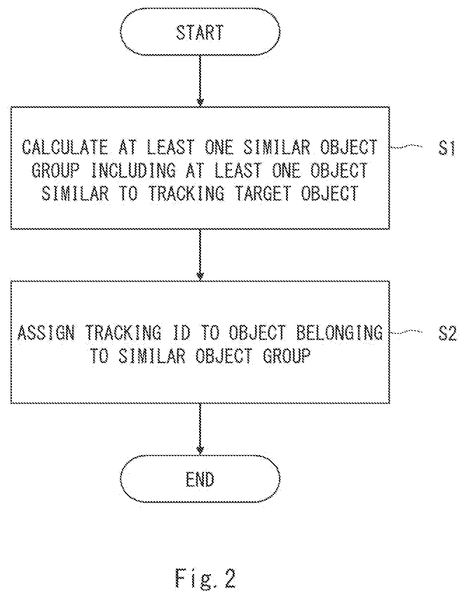

FIG. 2 is a flowchart of an example of the operation of the object tracking processing apparatus 1.

First, the object grouping processing unit 20 calculates at least one similar object group including at least one object similar to the tracking target object, on the basis of at least the feature amount of the tracking target object (step S1).

Next, the object tracking unit 50 assigns the tracking ID to the object belonging to the similar object group (step S2).

As described above, according to the first example embodiment, the tracking accuracy of the object appearing in a video can be improved.

This is attained by executing two-stage processing including processing of detecting the tracking target object in a frame and classifying the detected tracking target object into the similar object group (processing using non-spatio-temporal similarity) and processing of assigning the tracking ID for identifying the object belonging to the similar object group to the object, for each of the classified similar object groups (processing using spatial similarity). That is, a high tracking accuracy can be attained by making the collation of the same object for a wide range of frames and times and the consideration of spatio-temporal similarity compatible.

### Second Example Embodiment

Hereinafter, the object tracking processing apparatus 1 will be described in detail as a second example embodiment of the present disclosure. The second example embodiment is an example embodiment in which the first example embodiment is specified.

First, the outline of the object tracking processing apparatus 1 will be described.

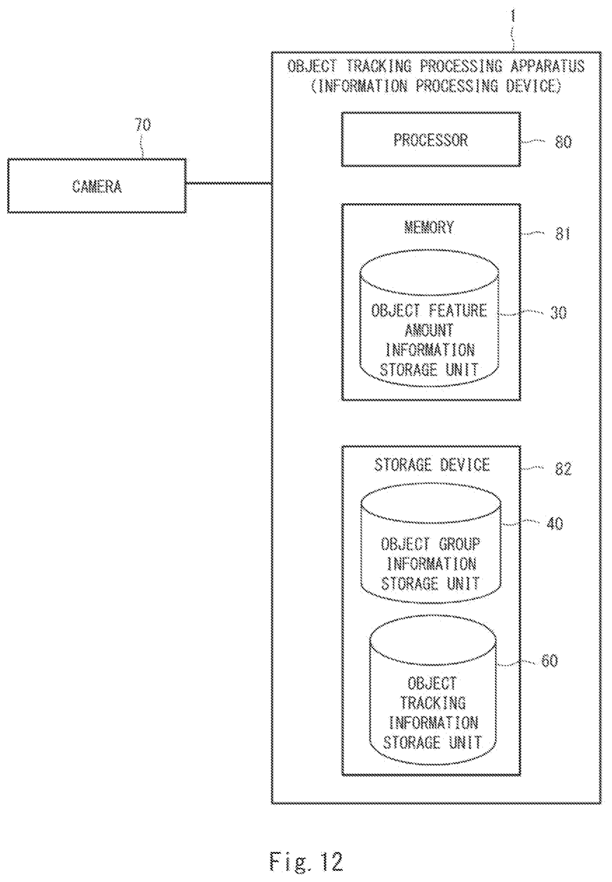

The object tracking processing apparatus 1 is a device that detects all objects appearing in a single video and tracks the same object across frames one after another (multi object tracking (MOT)). The single video indicates a video input from one camera 70 (refer to FIG. 12) or one video file (not illustrated). The frame indicates individual frames (hereinafter, also referred to as an image) configuring the single video.

The object tracking processing apparatus 1 executes the two-stage processing.

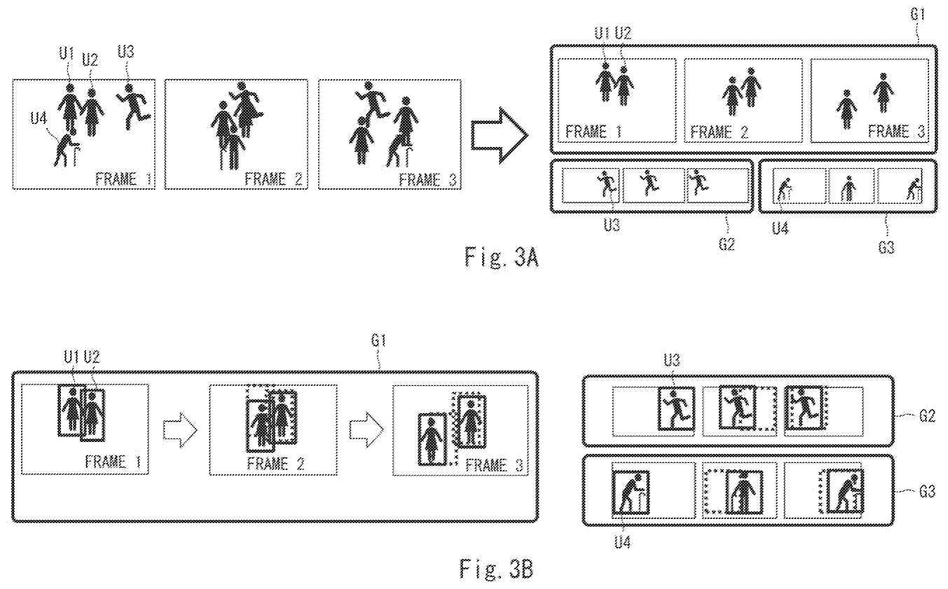

FIG. 3A is an image diagram of first-stage processing executed by the object tracking processing apparatus 1.

As the first-stage processing, the object tracking processing apparatus 1 executes processing (online processing) of detecting the tracking target object in the frame and classifying the detected tracking target object into the similar object group. This processing is processing using non-spatio-temporal similarity of objects. FIG. 3A illustrates that each of the tracking target objects (persons U1 to U4) is classified into three similar object groups G1 to G3 as a result of executing the first-stage processing on frames 1 to 3.

FIG. 3B is an image diagram of second-stage processing executed by the object tracking processing apparatus 1.

As the second-stage processing, the object tracking processing apparatus 1 executes processing (batch processing) of assigning the tracking ID for identifying the object belonging to the similar object group to the object, for each of the similar object groups classified by the first-stage processing. In this case, the object tracking processing apparatus 1 performs processing of determining the same object using the spatio-temporal similarity, for example, online tracking based on an overlap between a detected position of the object (refer to a rectangular frame drawn by a solid line in FIG. 3B) and a predicted position of a tracking object (refer to a rectangular frame drawn by a dotted line in FIG. 3B), and intersection over union (IoU). This processing is processing using the spatio-temporal similarity.

By executing the two-stage processing as described above, it is possible to attain a high tracking accuracy that is not capable of being attained by processing using either the non-spatio-temporal similarity or the spatio-temporal similarity of the object. In addition, by classifying the tracking target object into the similar object group, it is possible to parallelly execute the processing of assigning the tracking ID for identifying the object belonging to the similar object group to the object, for each of the similar object groups. As a result, the throughput can be improved.

Next, the details of the object tracking processing apparatus 1 will be described.

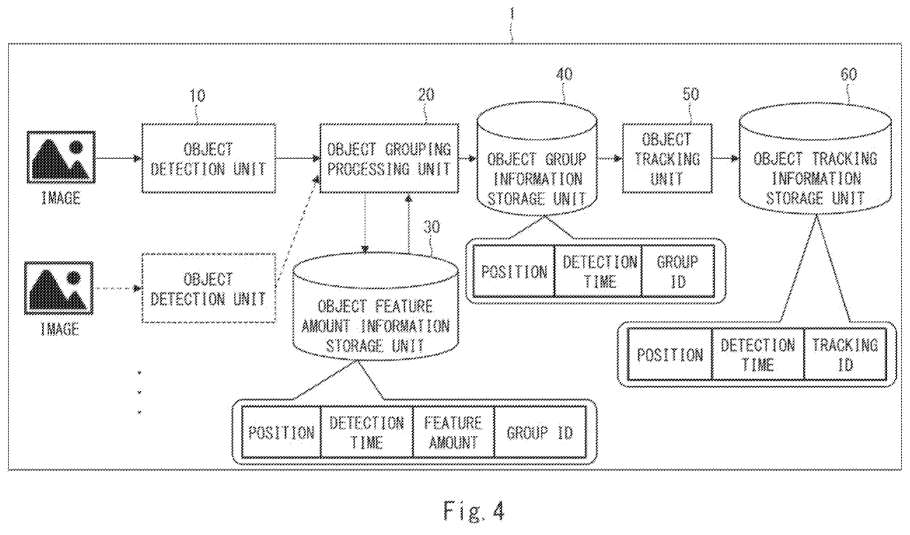

FIG. 4 is a block diagram illustrating the configuration of the object tracking processing apparatus 1 according to the second example embodiment.

As illustrated in FIG. 4, the object tracking processing apparatus 1 includes an object detection unit 10, an object grouping processing unit 20, an object feature amount information storage unit 30, an object group information storage unit 40, an object tracking unit 50, and an object tracking information storage unit 60.

The object detection unit 10 executes the processing of detecting the tracking target object (the position of tracking target object) in the frame configuring the single video and the feature amount of the tracking target object. This processing is the online processing executed each time when the frame is input. This processing is attained by executing predetermined image processing on the frame. As the predetermined image processing, various existing algorithms can be used. The object detected by the object detection unit 10 is, for example, a moving body (a moving object) such as a person, a vehicle, or a motorcycle. Hereinafter, an example in which the object detected by the object detection unit 10 is a person will be described. The feature amount is an object feature amount (ReIDs) and indicates data capable of calculating a similarity score between two objects by comparison. The position of the object detected by the object detection unit 10 is, for example, coordinates of a rectangular frame surrounding the object detected by the object detection unit 10. The feature amount of the object detected by the object detection unit 10 is, for example, the feature amount of the face of the person or the feature amount of the skeleton of the person. The object detection unit 10 may be built in the camera 70 (refer to FIG. 12) or may be provided outside the camera 70.

The object grouping processing unit 20 executes the processing of calculating at least one similar object group including at least one object similar to the tracking target object, on the basis of at least the feature amount of the tracking target object, by referring to the object feature amount information storage unit 30. In this case, the object grouping processing unit 20 executes the processing (clustering) of classifying the object detected by the object detection unit 10 into the similar object group by using the non-spatio-temporal similarity (for example, the similarity of face feature data or the similarity of person type feature data) of the object. This processing is the online processing executed each time when the object detection unit 10 detects the object. As a clustering algorithm, a data clustering/grouping technology based on the similarity with data at a wide time interval, for example, DBSCAN, k-means, or agglomerative clustering can be used.

Specifically, the object grouping processing unit 20 refers to the object feature amount information storage unit 30 to search for a similar object similar to the object detected by the object detection unit 10. In this case, all (for example, the feature amount for all the frames) stored in the object feature amount information storage unit 30 may be set as a search target, or a part (for example, the feature amount for 500 frames stored within 30 seconds from the current time point) stored in the object feature amount information storage unit 30 may be set as a search target.

In a case where the similar object is searched for as a result of the search, the object grouping processing unit 20 assigns a group ID of the similar object to the object detected by the object detection unit 10. Specifically, the object grouping processing unit 20 stores the position of the object, the detection time of the object, the feature amount of the object, and the group ID for identifying the similar object group to which the object belongs in the object feature amount information storage unit 30. In a case where the similar object is not searched for, a newly numbered group ID is assigned.

For each of the objects detected by the object detection unit 10, the object feature amount information storage unit 30 stores the position of the object, the detection time of the object, the feature amount of the object, and the group ID assigned to the object. Since the object feature amount information storage unit 30 is frequently accessed from the object grouping processing unit 20, it is desirable that the object feature amount information storage unit is a storage device (a memory or the like) that is capable of performing read and write at a high speed.

The object group information storage unit 40 stores information relevant to the object belonging to the similar object group. Specifically, for each of the objects detected by the object detection unit 10, the object group information storage unit 40 stores the position of the object, the detection time of the object, and the group ID for identifying the similar object group to which the object belongs. Note that, the object group information storage unit 40 may further store the feature amount of the object. Since the object group information storage unit 40 is not frequently accessed, compared to the object feature amount information storage unit 30, the object group information storage unit may not be a storage device (a memory or the like) that is capable of performing read and write at a high speed. For example, the object group information storage unit 40 may be a hard disk device.

The object tracking unit 50 executes the processing of assigning the tracking ID for identifying the object belonging to the similar object group calculated by the object grouping processing unit 20 to the object. The tracking ID indicates an identifier assigned to the same object across the frames one after another. This processing is the batch processing of a temporal interval (a time interval) executed each time when a predetermined time (for example, 5 minutes) elapses. This batch processing is processing of acquiring the updated information relevant to the object belonging to the similar object group from the object group information storage unit 40 and assigning the tracking ID to the object belonging to the similar object group, on the basis of the acquired information. In this case, the object tracking unit 50 performs processing of determining the same object using the spatio-temporal similarity, for example, the online tracking based on the overlap between the detected position of the object and the predicted position of the tracking object, and the intersection over union (IoU). As this algorithm, for example, a Hungarian method can be used. The Hungarian method is an algorithm that calculates a cost from the degree of overlap between the predicted positions of the detection object and the tracking object and determines the assignment that minimizes the cost. The Hungarian method will be further described below. Note that, this algorithm is not limited to the Hungarian method, and other algorithms, for example, a greedy method can be used. Note that, in the same-object determination of the object tracking unit 50, not only the spatio-temporal similarity but also non-spatio-temporal similarity may be used.

The number of object tracking units 50 is the same as the number of similar object groups calculated by the object grouping processing unit 20 (the same number of object tracking units are provided). Each of the object tracking units 50 executes the processing of assigning the tracking ID for identifying the object belonging to the similar object group (one similar object group different from each other) associated with each of the object tracking units to the object. As described above, in this example embodiment, in a case where the object grouping processing unit 20 calculates a plurality of similar object groups, the processing of assigning the tracking ID for identifying the object belonging to the similar object group to the object can be parallelly executed. Note that, there may be one object or a plurality of objects belonging to the similar object group. For example, in FIG. 3A, two persons U1 and U2 belong to the similar object group G1, one person U3 belongs to the similar object group G2, and one person U4 belongs to the similar object group G3.

The object tracking information storage unit 60 stores the tracking ID assigned by the object tracking unit 50. Specifically, for each of the objects, the object tracking information storage unit 60 stores the position of the object, the detection time of the object, and the group ID for identifying the similar object group to which the object belongs. Since the object tracking information storage unit 60 is not frequently accessed compared to the object feature amount information storage unit 30, the object tracking information storage unit may not be a storage device (a memory or the like) that is capable of performing read and write at a high speed. For example, the object tracking information storage unit 60 may be a hard disk device.

Next, as an operation example of the object tracking processing apparatus 1, processing of grouping similar person types (the first-stage processing) will be described.

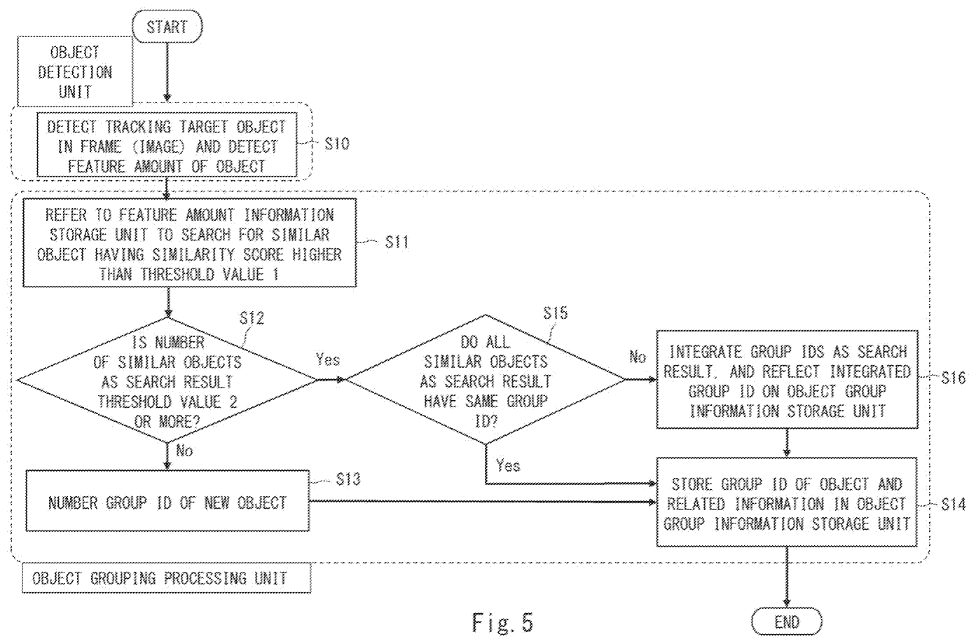

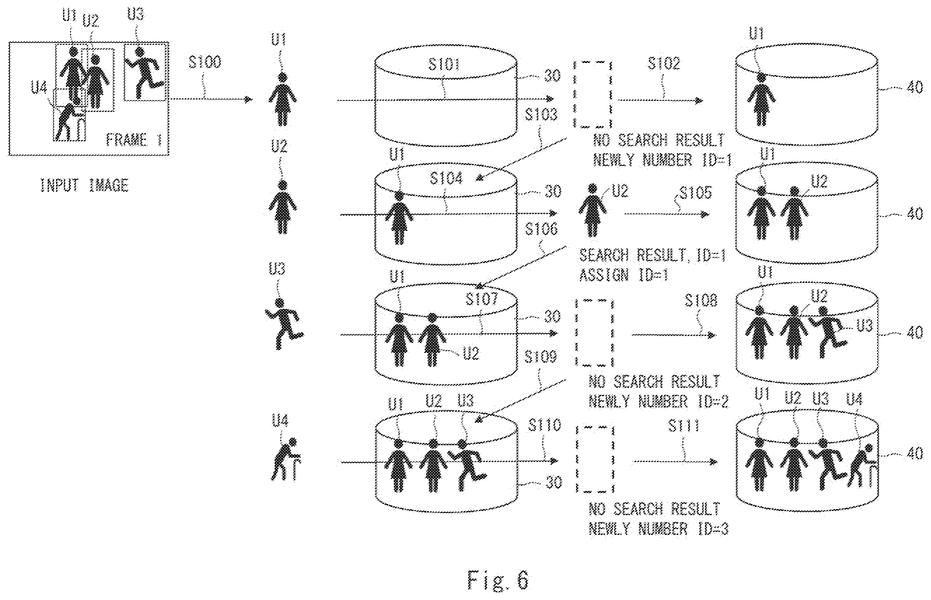

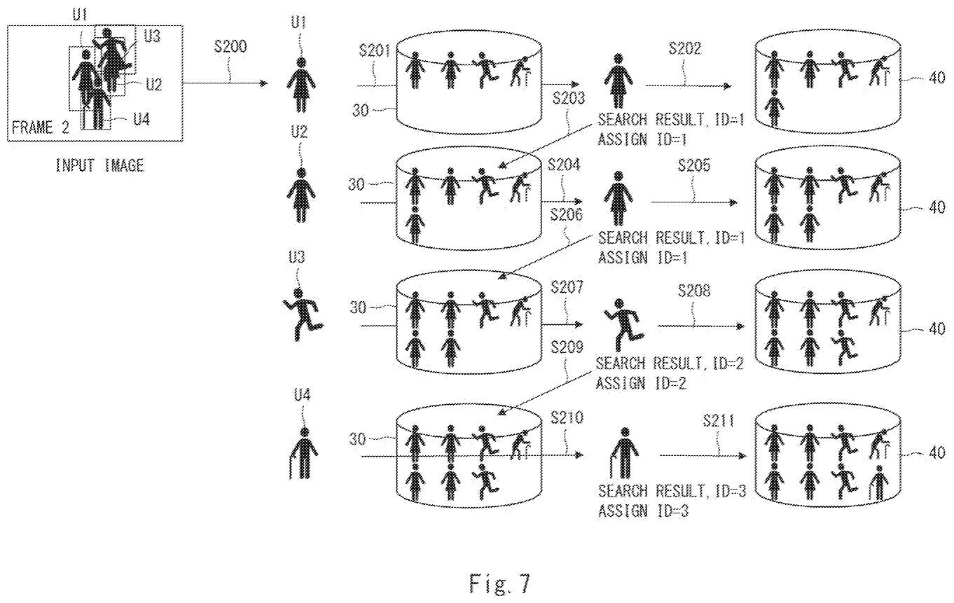

FIG. 5 is a flowchart of the processing of grouping the objects detected by the object detection unit 10. FIGS. 6 and 7 are image diagrams of the processing of grouping the objects detected by the object detection unit 10.

Hereinafter, as a premise, it is assumed that the frames configuring the single video captured by the camera 70 (refer to FIG. 12) are sequentially input to the object detection unit 10. For example, it is assumed that the frame 1, the frame 2, the frame 3 . . . are sequentially input to the object detection unit 10 in this order. In addition, it is assumed that nothing is initially stored in the object feature amount information storage unit 30, the object group information storage unit 40, and the object tracking information storage unit 60.

The following processing is executed for each of the frames (each time when the frame is input).

First, processing in a case where the frame 1 is input will be described.

First, in a case where the frame 1 is input, the object detection unit 10 detects the tracking target object in the frame 1 (the image) and executes processing of detecting (calculating) the feature amount of the tracking target object (step S10).

Here, as illustrated in FIG. 6, it is assumed that the frame 1 (an image including the persons U1 to U4) is input, the persons U1 to U4 in the frame 1 are detected as the tracking target object (step S100), and the feature amount of the detected persons U1 to U4 is detected.

Next, the object grouping processing unit 20 refers to the object feature amount information storage unit 30, for each of the objects detected in step S10, and searches for a similar object having a similarity score higher than a threshold value 1 (step S11). The threshold value 1 is a threshold value representing the lower limit of the similarity score. In this case, all (for example, the feature amount for all the frames) stored in the object feature amount information storage unit 30 may be set as a search target, or a part (for example, the feature amount for 500 frames stored within 30 seconds from the current time point) stored in the object feature amount information storage unit 30 may be set as a search target. Note that, by setting a part (for example, the feature amount for 500 frames stored within 30 seconds from the current time point) stored in the object feature amount information storage unit 30 as a search target, it is possible to suppress the deterioration of the freshness of the feature amount.

For example, for the person U1 detected in step S10 (step S100), the similar object is not searched for even in a case where the processing of step S11 is executed. This is because nothing is stored in the object feature amount information storage unit 30 at this time (refer to step S101 in FIG. 6).

Next, the object grouping processing unit 20 determines whether the number of similar objects as the search result in step S11 is a threshold value 2 or more (step S12). The threshold value 2 is a threshold value representing the lower limit of the number of similar objects.

For the person U1 detected in step S10, no similar object is searched for even in a case where the processing of step S11 is executed, and thus, the determination result of step S12 is No.

In this case, the object grouping processing unit 20 numbers the group ID (for example, 1) of a new object (the person U1) to the person U1 detected in step S10 (step S13), and stores the numbered group ID and the related information (the position of the person U1 and the detection time of the person U1) in the object group information storage unit 40 in association with each other (step S14 and step S102 in FIG. 6). In addition, the object grouping processing unit 20 stores the group ID numbered in step S13 and the related information (the position of the person U1, the detection time of the person U1, and the feature amount of the person U1) in the object feature amount information storage unit 30 in association with each other (refer to step S103 in FIG. 6).

On the other hand, in a case where the processing of step S11 is executed for the person U2 detected in step S10, the person U1 is searched for as a similar object. This is because the group ID and the related information (the position of the person U1, the detection time of the person U1, and the feature amount of the person U1) of the person U1 are stored in the object feature amount information storage unit 30 at this time (refer to step S104 in FIG. 6). Therefore, the determination result in step S12 is Yes (in a case where the threshold value 2 is 0).

In this case, the object grouping processing unit 20 determines whether all the similar objects as the search result in step S11 have the same group ID (step S15).

For the person U2 detected in step S10, since all the similar objects (the persons U1) as the search result in step S11 have the same group ID, the determination result in step S15 is Yes.

In this case, for the person U2 detected in step S10, the object grouping processing unit 20 stores the group ID and the related information (the position of the person U2 and the detection time of the person U2) of the similar object (the person U1) detected in step S11 in the object group information storage unit 40 in association with each other (step S14 and step S105 in FIG. 6). Furthermore, the object grouping processing unit 20 stores the group ID of the similar object (the person U1) detected in step S11 and the related information (the position of the person U1, the detection time of the person U1, and the feature amount of the person U1) in the object feature amount information storage unit 30 in association with each other (refer to step S106 in FIG. 6).

On the other hand, for the person U3 detected in step S10, the similar object is not searched for even in a case where the processing of step S11 is executed, and thus, the determination result of step S12 is No.

In this case, the object grouping processing unit 20 numbers the group ID (for example, 2) of a new object (the person U3) to the person U3 detected in step S10 (step S13), and stores the numbered group ID and the related information (the position of the person U3 and the detection time of the person U3) in the object group information storage unit 40 in association with each other (step S14 and step S108 in FIG. 6). In addition, the object grouping processing unit 20 stores the group ID numbered in step S13 and the related information (the position of the person U3, the detection time of the person U3, and the feature amount of the person U3) in the object feature amount information storage unit 30 in association with each other (refer to step S109 in FIG. 6).

Similarly, for the person U4 detected in step S10, the similar object is not searched for even in a case where the processing of step S11 is executed, and thus, the determination result of step S12 is No.

In this case, the object grouping processing unit 20 numbers the group ID (for example, 3) of a new object (the person U4) to the person U4 detected in step S10 (step S13), and stores the numbered group ID and the related information (the position of the person U4 and the detection time of the person U4) in the object group information storage unit 40 in association with each other (step S14 and step S111 in FIG. 6). In addition, the object grouping processing unit 20 stores the group ID numbered in step S13 and the related information (the position of the person U4, the detection time of the person U4, and the feature amount of the person U4) in the object feature amount information storage unit 30 in association with each other (not illustrated).

Next, processing in a case where the frame subsequent to the frame 1 (for example, the frame 2) is input will be described.

First, in a case where the frame 2 is input, the object detection unit 10 detects the tracking target object in the frame 2 (the image) and executes the processing of detecting (calculating) the feature amount of the tracking target object (step S10).

Here, as illustrated in FIG. 7, it is assumed that the frame 2 (the image including the persons U1 to U4) is input, the persons U1 to U4 in the frame 2 are detected as the tracking target object (step S200), and the feature amount of the detected persons U1 to U4 is detected.

Next, the object grouping processing unit 20 refers to the object feature amount information storage unit 30, for each of the objects detected in step S10, and searches for a similar object having a similarity score higher than a threshold value 1 (step S11). The threshold value 1 is a threshold value representing the lower limit of the similarity score. In this case, all (for example, the feature amount for all the frames) stored in the object feature amount information storage unit 30 may be set as a search target, or a part (for example, the feature amount for 500 frames stored within 30 seconds from the current time point) stored in the object feature amount information storage unit 30 may be set as a search target. Note that, by setting a part (for example, the feature amount for 500 frames stored within 30 seconds from the current time point) stored in the object feature amount information storage unit 30 as a search target, it is possible to suppress the deterioration of the freshness of the feature amount.

For example, in a case where the processing of step S11 is executed for the person U1 detected in step S10 (step S200), the persons U1 and U2 are searched for as a similar object. This is because the group ID and the related information (the position of the person U1, the detection time of the person U1, and the feature amount of the person U1) of the person U1, and the group ID and the related information (the position of the person U2, the detection time of the person U2, and the feature amount of the person U2) of the person U2 are stored in the object feature amount information storage unit 30 at this time (refer to step S201 in FIG. 6). Therefore, the determination result in step S12 is Yes (in a case where the threshold value 2 is 0).

In this case, the object grouping processing unit 20 determines whether all the similar objects as the search result in step S11 have the same group ID (step S15).

For the person U1 detected in step S10 (step S200), since all the similar objects (the persons U1 and U2) as the search result in step S11 have the same group ID, the determination result in step S15 is Yes.

In this case, for the person U1 detected in step S10 (step S200), the object grouping processing unit 20 stores the group ID of the similar object (the persons U1 and U2) detected in step S11 and the related information (the position of the person U1 and the detection time of the person U1) in the object group information storage unit 40 in association with each other (step S14 and step S202 in FIG. 6). Furthermore, the object grouping processing unit 20 stores the group ID of the similar object (the persons U1 and U2) detected in step S11 and the related information (the position of the person U1, the detection time of the person U1, and the feature amount of the person U1) in the object feature amount information storage unit 30 in association with each other (refer to step S203 in FIG. 7).

In a case where the similar objects (the persons U1, U2, and U3) as the search result in step S11 are not all the same group ID, for example, in a case where the group ID of the person U1 is 1, the group ID of the person U2 is 2, and the group ID of the person U3 is 3, the determination result in step S15 is No. In this case, the object grouping processing unit 20 executes processing of integrating the group IDs. Specifically, the object grouping processing unit 20 integrates the group IDs as the search result, and stores the integrated group ID in the object group information storage unit 40 (step S16). For example, the object grouping processing unit 20 changes all the persons (here, the person U2) belonging to the similar object group having the group ID of 2 and all the persons (here, the person U3) belonging to the similar object group having the group ID of 3 to Group ID=1.

As a result, a person (data) erroneously classified into another similar object group (data cluster) in the middle of processing can be integrated into the same similar object group.

In a case where the processing of integrating the group IDs is executed as described above, for the person U1 detected in step S10, the object grouping processing unit 20 stores the integrated group ID and the related information (the position of the person U1 and the detection time of the person U1) in the object group information storage unit 40 in association with each other (step S14). Furthermore, the object grouping processing unit 20 stores the integrated group ID and the related information (the position of the person U1, the detection time of the person U1, and the feature amount of the person U1) in the object feature amount information storage unit 30 in association with each other. The same applies to the persons U2 and U3.

Similarly, in a case where the processing of step S11 is executed for the person U2 detected in step S10 (step S200), the persons U1 and U2 are searched for as a similar object. This is because the group ID and the related information (the position of the person U1, the detection time of the person U1, and the feature amount of the person U1) of the person U1, and the group ID and the related information (the position of the person U2, the detection time of the person U2, and the feature amount of the person U2) of the person U2 are stored in the object feature amount information storage unit 30 at this time (refer to step S204 in FIG. 7). Therefore, the determination result in step S12 is Yes (in a case where the threshold value 2 is 0).

In this case, the object grouping processing unit 20 determines whether all the similar objects as the search result in step S11 have the same group ID (step S15).

For the person U2 detected in step S10 (step S200), since all the similar objects (the persons U1 and U2) as the search result in step S11 have the same group ID, the determination result in step S15 is Yes.

In this case, for the person U2 detected in step S10 (step S200), the object grouping processing unit 20 stores the group ID of the similar object (the persons U1 and U2) detected in step S11 and the related information (the position of the person U2 and the detection time of the person U2) in the object group information storage unit 40 in association with each other (step S14 and step S205 in FIG. 7). Furthermore, the object grouping processing unit 20 stores the group ID of the similar object (the persons U1 and U2) detected in step S11 and the related information (the position of the person U2, the detection time of the person U2, and the feature amount of the person U2) in the object feature amount information storage unit 30 in association with each other (refer to step S206 in FIG. 7).

Similarly, in a case where the processing of step S11 is executed for the person U3 detected in step S10 (step S200), the person U3 is searched for as a similar object. This is because the group ID and the related information (the position of the person U3, the detection time of the person U3, and the feature amount of the person U3) of the person U3 are stored in the object feature amount information storage unit 30 at this time (refer to step S207 in FIG. 7). Therefore, the determination result in step S12 is Yes (in a case where the threshold value 2 is 0).

In this case, the object grouping processing unit 20 determines whether all the similar objects as the search result in step S11 have the same group ID (step S15).

For the person U3 detected in step S10 (step S200), since all the similar objects (the persons U3) as the search result in step S11 have the same group ID, the determination result in step S15 is Yes.

In this case, for the person U3 detected in step S10 (step S200), the object grouping processing unit 20 stores the group ID and the related information (the position of the person U3 and the detection time of the person U3) of the similar object (the person U3) detected in step S11 in the object group information storage unit 40 in association with each other (step S14 and step S208 in FIG. 7). Furthermore, the object grouping processing unit 20 stores the group ID of the similar object (the person U3) detected in step S11 and the related information (the position of the person U3, the detection time of the person U3, and the feature amount of the person U3) in the object feature amount information storage unit 30 in association with each other (refer to step S209 in FIG. 7).

Similarly, in a case where the processing of step S11 is executed for the person U4 detected in step S10 (step S200), the person U4 is searched for as a similar object. This is because the group ID and the related information (the position of the person U4, the detection time of the person U4, and the feature amount of the person U4) of the person U4 are stored in the object feature amount information storage unit 30 at this time (refer to step S210 in FIG. 7). Therefore, the determination result in step S12 is Yes (in a case where the threshold value 2 is 0).

In this case, the object grouping processing unit 20 determines whether all the similar objects as the search result in step S11 have the same group ID (step S15).

For the person U4 detected in step S10 (step S200), since all the similar objects (the persons U4) as the search result in step S11 have the same group ID, the determination result in step S15 is Yes.

In this case, for the person U4 detected in step S10 (step S200), the object grouping processing unit 20 stores the group ID and the related information (the position of the person U4 and the detection time of the person U4) of the similar object (the person U4) detected in step S11 in the object group information storage unit 40 in association with each other (step S14 and step S211 in FIG. 7). Furthermore, the object grouping processing unit 20 stores the group ID of the similar object (the person U4) detected in step S11 and the related information (the position of the person U4, the detection time of the person U4, and the feature amount of the person U4) in the object feature amount information storage unit 30 in association with each other (not illustrated).

Note that, the same processing as for the frame 2 is executed for the frames subsequent to the frame 2.

By executing the processing described in the flowchart 1, the group ID and the related information of each of the objects detected in step S10 are stored in the object feature amount information storage unit 30 and the object group information storage unit 40 every moment.

An example in which the processing of the flowchart described in FIG. 5 is executed for each of the consecutive frames such as the frame 1, the frame 2, and the frame 3 . . . has been described above, but the present disclosure is not limited thereto. For example, the processing of the flowchart described in FIG. 5 may be executed for every other frame (or a plurality of frames) such as the frame 1, the frame 3, and the frame 5 As a result, the throughput can be improved.

Next, as an operation example of the object tracking processing apparatus 1, the processing (the second-stage processing) of assigning the tracking ID for identifying the object belonging to the similar object group calculated by the object grouping processing unit 20 to the object will be described. This processing is executed by the object tracking unit 50.

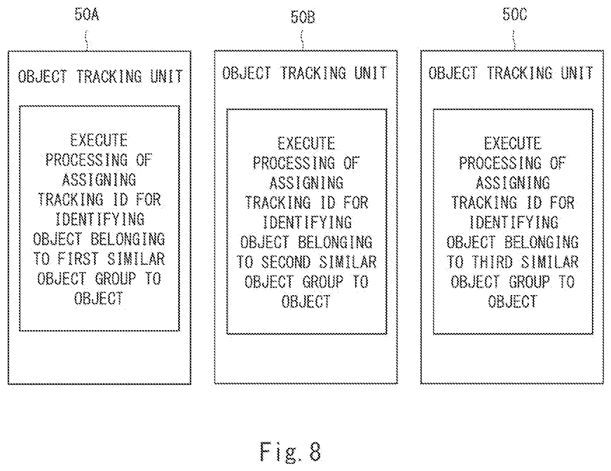

The number of object tracking units 50 is the same as the number of similar object groups calculated by the object grouping processing unit 20 (the same number of object tracking units are provided). For example, in a case where three similar object groups are formed as a result of executing the processing of the flowchart in FIG. 5, three object tracking units 50A to 50C exist (are generated) as illustrated in FIG. 8. FIG. 8 illustrates a state in which each of the object tracking units 50A to 50C parallelly executes the processing of assigning the tracking ID for identifying the object belonging to the similar object group (one similar object group different from each other) associated with each of the object tracking units to the object.

The object tracking unit 50A executes processing of assigning a tracking ID for identifying an object (here, the persons U1 and U2) belonging to a first similar object group (here, a similar object group having a group ID of 1) to the object. The object tracking unit 50B executes processing of assigning a tracking ID for identifying an object (here, the person U3) belonging to a second similar object group (here, a similar object group having a group ID of 2) to the object. The object tracking unit 50C executes processing of assigning a tracking ID for identifying an object (here, the person U4) belonging to a third similar object group (here, a similar object group having a group ID of 3) to the object. Such processing is parallelly executed.

Hereinafter, processing in which the object tracking unit 50A assigns the tracking ID for identifying the object (here, the persons U1 and U2) belonging to the first similar object group (the similar object group having the group ID of 1) to the object will be described as a representative.

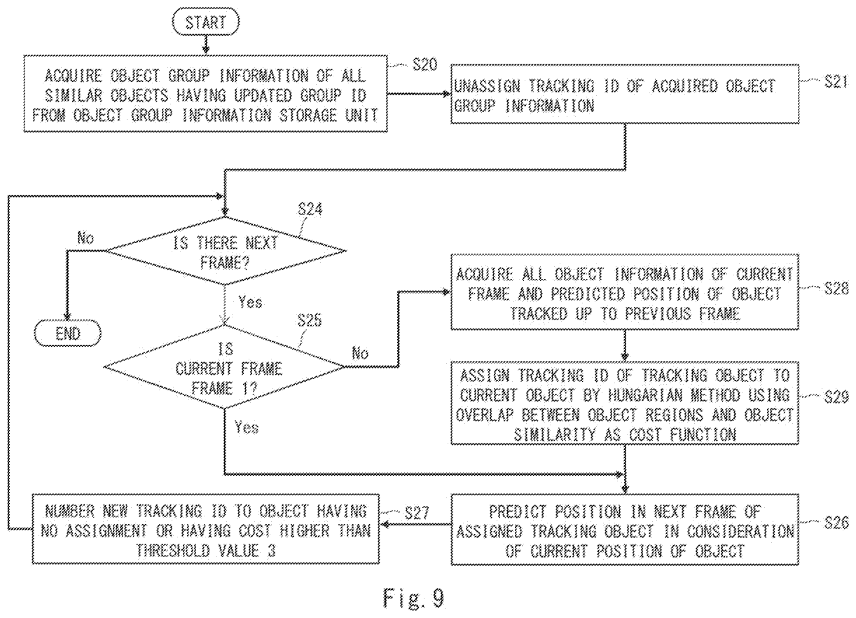

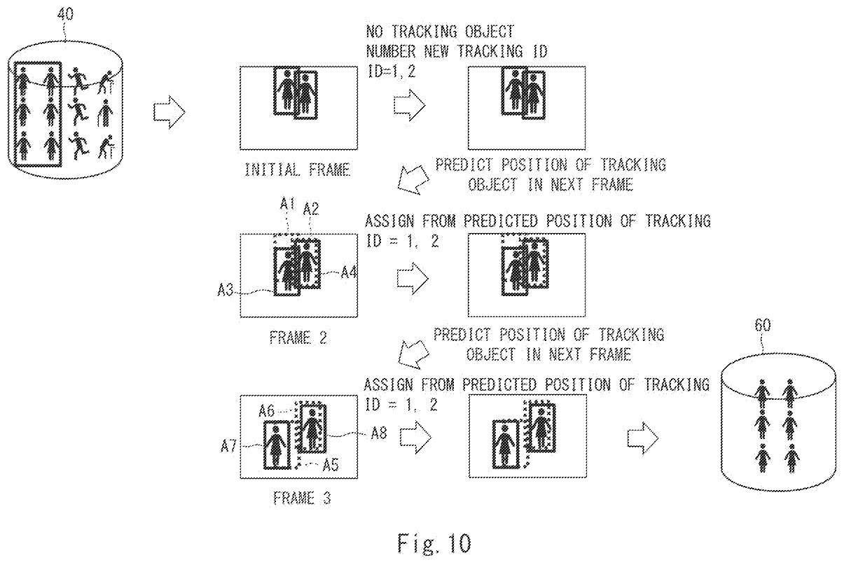

FIG. 9 is a flowchart of the processing of assigning the tracking ID for identifying the object belonging to the similar object group calculated by the object grouping processing unit 20 to the object. FIG. 10 is an image diagram of the processing of assigning the tracking ID for identifying the object belonging to the similar object group calculated by the object grouping processing unit 20 to the object.

First, in a case where a predetermined time (for example, 5 minutes) has elapsed, the object tracking unit 50A acquires the object group information (the group ID and the related information) of all the similar objects having the updated group ID (here, group ID=1, the same applies hereinafter) from the object group information storage unit 40 (step S20).

The expression “updated” indicates a case where the same group ID and related information as those of the group ID already stored are additionally stored in the object group information storage unit 40, and a case where a new group ID and related information are additionally stored in the object group information storage unit 40, and also includes a case where the processing of step S16 (the processing of integrating group IDs) is executed and the processing result is stored in the object group information storage unit 40 (step S14). Note that, in a case where there is no update, the processing of the flowchart illustrated in FIG. 9 is not executed even after a predetermined time (for example, 5 minutes) has elapsed.

Next, the object tracking unit 50A unassigns the tracking ID of the object group information acquired in step S20 (step S21).

Next, the object tracking unit 50A determines whether there is the next frame (step S24). Here, since there is the next frame (the frame 2), the determination result of step S24 is Yes.

Next, the object tracking unit 50A determines whether the current frame (a processing target frame) is the frame 1 (step S25). Here, since the current frame (the processing target frame) is the frame 1 (a first frame), the determination result of step S25 is Yes.

Next, the object tracking unit 50A predicts the position in the next frame of the assigned tracking object in consideration of the current position of the object (step S26).

For example, the object tracking unit 50A predicts the position in the next frame (frame 2) of each of the persons U1 and U2 belonging to the similar object group having the group ID of 1 in the frame 1 (the first frame). As an algorithm of this prediction, for example, an algorithm disclosed in https://arxiv.org/abs/1602.00763 (code: https://github.com/abewley/sort, GPL v3) can be used. Here, it is assumed that position of two rectangular frames A1 and A2 drawn by a dotted line in the frame 2 in FIG. 10 is predicted as the predicted position of the persons U1 and U2.

Next, the object tracking unit 50A assigns a new tracking ID to an object having no assignment or having a cost higher than a threshold value 3 (step S27). The threshold value 3 is a threshold value representing the upper limit of the cost calculated by the overlap between the object regions and the object similarity.

Here, since the tracking ID has not been assigned to the person U1 belonging to the similar object group having the group ID of 1 in the frame 1 (the first frame), the object tracking unit 50A assigns a new tracking ID (for example, 1) to the person U1 (step S27), and stores the assigned new tracking ID (=1) and the related information (the position of the person U1 and the detection time of the person U1) in the object tracking information storage unit 60 in association with each other. Similarly, since the tracking ID has not been assigned to the person U2 belonging to the similar object group having the group ID of 1 in the frame 1 (the first frame), the object tracking unit 50A assigns a new tracking ID (for example, 2) to the person U2 (step S27), and stores the assigned new tracking ID (=2) and the related information (the position of the person U2 and the detection time of the person U2) in the object tracking information storage unit 60 in association with each other.

Next, the object tracking unit 50A determines whether there is the next frame (step S24). Here, since there is the next frame (the frame 2), the determination result of step S24 is Yes.

Next, the object tracking unit 50A determines whether the current frame (a processing target frame) is the frame 1 (step S25). Here, since the current frame (the processing target frame) is the frame 2, the determination result of step S25 is No.

Next, the object tracking unit 50A acquires all the object information of the current frame (the frame 2) and the predicted position of the object (the persons U1 and U2) tracked up to the previous frame (the frame 1) (step S28). Here, it is assumed that position of two rectangular frames A1 and A2 drawn by the dotted line in the frame 2 in FIG. 10 (the position predicted in step S26) is acquired as the predicted position of the object (the persons U1 and U2).

Next, the object tracking unit 50 assigns the tracking ID of the tracking object to the current object by the Hungarian method using the overlap between the object regions and the object similarity as a cost function (step S29). For example, the cost is calculated from the degree of overlap between the predicted positions of the detection object and the tracking object, and the assignment that minimizes the cost is determined.

Here, a specific example of the processing of assigning the tracking ID of the tracking object to the current object by the Hungarian method will be described.

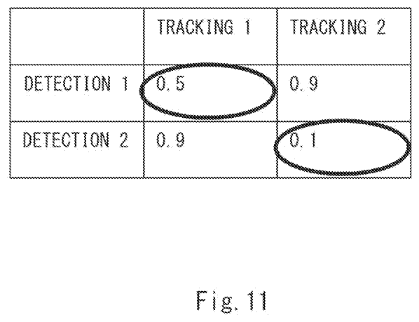

In this processing, a matrix (a table) illustrated in FIG. 11 is used. FIG. 11 illustrates an example of the matrix (the table) used in the processing of assigning the tracking ID for identifying the object belonging to the similar object group calculated by the object grouping processing unit 20 to the object. “Detection 1”, “Detection 2”, “Tracking 1”, and “Tracking 2” in this matrix have the following meanings.

That is, in FIG. 10, two rectangular frames A1 and A2 drawn by the dotted line in the frame 2 represent the predicted position of the objects (the persons U1 and U2) predicted in the previous frame (the frame 1). One of the two rectangular frames A1 and A2 represents “Tracking 1”, and the other represents “Tracking 2”.

In FIG. 10, two rectangular frames A3 and A4 drawn by a solid line in the frame 2 represent the position of the object (the persons U1 and U2) detected in the current frame (the frame 2). One of the two rectangular frames A3 and A4 represents “Detection 1”, and the other represents “Detection 2”.

Note that, the matrix (the table) illustrated in FIG. 11 is a 2×2 matrix, but is not limited thereto, and may be an N1×N2 matrix other than 2×2, in accordance with the number of objects. N1 and N2 are each an integer of 1 or more.

The numerical values (hereinafter, also referred to as a cost) described in the matrix (the table) illustrated in FIG. 11 have the following meanings.

For example, 0.5 described at the intersection point between “Tracking 1” and “Detection 1” is a numerical value obtained by subtracting the degree of overlap (an overlap region) between the predicted position representing “Tracking 1” (one rectangular frame A1 drawn by the dotted line in the frame 2 in FIG. 10) and the position representing “Detection 1” (one rectangular frame A3 drawn by the solid line in the frame 2 in FIG. 10)/2 from 1.0. This numerical value indicates that both positions completely overlap when the numerical value is 0, and indicates that both positions do not overlap at all when the numerical value is 1. In addition, this numerical value indicates that the degree of overlap between both positions increases as the numerical value decreases (is closer to 0), whereas the degree of overlap between both positions decreases as the numerical value increases (is closer to 1). The same applies to other numerical values (0.9 and 0.1) described in a matrix (a table) illustrated in FIG. 11.

In the case of the matrix (the table) illustrated in FIG. 11, the object tracking unit 50A determines assignment with the lowest cost (with a high degree of overlap). Specifically, the object tracking unit 50A assigns the tracking ID of “Tracking 1” with the lowest cost (the cost is 0.5) as the tracking ID of Detection 1 (for example, the person U1). In this case, for the person U1, the object tracking unit 50A stores the assigned tracking ID (=1) and the related information (the position of the person U1 and the detection time of the person U1) in the object tracking information storage unit 60 in association with each other.

On the other hand, the object tracking unit 50A assigns the tracking ID of “Tracking 2” with the lowest cost (the cost is 0.1) as the tracking ID of Detection 2 (for example, the person U2). In this case, for the person U2, the object tracking unit 50A stores the assigned tracking ID (=2) and the related information (the position of the person U2 and the detection time of the person U2) in the object tracking information storage unit 60 in association with each other.

Next, the object tracking unit 50A predicts the position in the next frame of the assigned tracking object in consideration of the current position of the object (step S26).

For example, the object tracking unit 50A predicts the position in the next frame (the frame 3) of each of the persons U1 and U2 belonging to the similar object group having the group ID of 1 in the frame 2. Here, it is assumed that the position of two rectangular frames A5 and A6 drawn by a dotted line in the frame 3 in FIG. 10 is predicted as the predicted position of the persons U1 and U2.

Next, the object tracking unit 50A assigns a new tracking ID to an object having no assignment or having a cost higher than a threshold value 3 (step S27). The threshold value 3 is a threshold value representing the upper limit of the cost calculated by the overlap between the object regions and the object similarity.

Here, since the tracking ID has been assigned to the persons U1 and U2 belonging to the similar object group having the group ID of 1 in the frame 2 and the cost is lower than the threshold value 3, the processing of step S26 is not executed.

Next, the object tracking unit 50A determines whether there is the next frame (step S24). Here, since there is the next frame (the frame 3), the determination result of step S24 is Yes.

Next, the object tracking unit 50A determines whether the current frame (the processing target frame) is the frame 1 (step S25). Here, since the current frame (the processing target frame) is the frame 3, the determination result of step S25 is No.

Next, the object tracking unit 50A acquires all the object information of the current frame (the frame 3) and the predicted position of the object (the persons U1 and U2) tracked up to the previous frame (the frame 2) (step S28). Here, it is assumed that position of two rectangular frames A5 and A6 drawn by the dotted line in the frame 3 in FIG. 10 (the position predicted in step S26) is acquired as the predicted position of the object (the persons U1 and U2).

Next, the object tracking unit 50A assigns the tracking ID of the tracking object to the current object by the Hungarian method using the overlap between the object regions and the object similarity as a cost function (step S29).

That is, as described above, the object tracking unit 50A determines the assignment with the lowest cost (with a high degree of overlap). Specifically, the object tracking unit 50A assigns the tracking ID of “Tracking 1” with the lowest cost as the tracking ID of Detection 1 (for example, the person U1). In this case, for the person U1, the object tracking unit 50A stores the assigned tracking ID and the related information (the position of the person U1 and the detection time of the person U1) in the object tracking information storage unit 60 in association with each other.

On the other hand, the object tracking unit 50A assigns the tracking ID of “Tracking 2” with the lowest cost as the tracking ID of Detection 2 (for example, the person U2). In this case, for the person U2, the object tracking unit 50A stores the assigned tracking ID and the related information (the position of the person U2 and the detection time of the person U2) in the object tracking information storage unit 60 in association with each other.

The above processing is repeatedly executed until there is no next frame (step S24: No).

Next, a hardware configuration example of the object tracking processing apparatus 1 (an information processing device) described in the second example embodiment will be described. FIG. 12 is a block diagram illustrating the hardware configuration example of the object tracking processing apparatus 1 (the information processing device).

As illustrated in FIG. 12, the object tracking processing apparatus 1 is an information processing device such as a server including a processor 80, a memory 81, a storage device 82, and the like. The server may be a physical machine or a virtual machine. Furthermore, one camera 70 is connected to the object tracking processing apparatus 1 through a communication line (for example, the Internet).

The processor 80 functions as the object detection unit 10, the object grouping processing unit 20, and the object tracking unit 50 by executing software (a computer program) read from the memory 81 such as a RAM. Such functions may be implemented in one server or may be distributed and implemented in a plurality of servers. Even in a case where the functions are distributed and implemented in the plurality of servers, the processing of each of the above-described flowcharts can be implemented by the plurality of servers communicating with each other through a communication line (for example, the Internet). A part or all of such functions may be attained by hardware.

In addition, the number of object tracking units 50 is the same as the number of similar object groups divided by the object grouping processing unit 20 (the same number of object tracking units are provided), but each of the object tracking units 50 may be implemented in one server or may be distributed and implemented in the plurality of servers. Even in a case where the functions are distributed and implemented in the plurality of servers, the processing of each of the above-described flowcharts can be implemented by the plurality of servers communicating with each other through a communication line (for example, the Internet).

The processor 80 may be, for example, a microprocessor, a micro processing unit (MPU), or a central processing unit (CPU). The processor may include a plurality of processors.

The memory 81 is constituted by a combination of a volatile memory and a nonvolatile memory. The memory may include a storage disposed away from the processor. In this case, the processor may access the memory through an I/O interface, not illustrated.

The storage device 82 is, for example, a hard disk device.

In the example in FIG. 11, the memory is used to store a group of software modules. The processor is capable of performing the processing of the object tracking processing apparatus and the like described in the above-described example embodiments by reading and executing the group of software modules from the memory.

The object feature amount information storage unit, the object group information storage unit, and the object tracking information storage unit may be provided in one server, or may be distributed and provided in the plurality of servers.

As described above, according to the second example embodiment, the tracking accuracy of the object appearing in the video can be improved.

This is attained by executing two-stage processing including processing of detecting the tracking target object in a frame and classifying the detected tracking target object into the similar object group (processing using non-spatio-temporal similarity) and processing of assigning the tracking ID for identifying the object belonging to the similar object group to the object, for each of the classified similar object groups (processing using spatial similarity). That is, a high tracking accuracy can be attained by making the collation of the same object for a wide range of frames and times and the consideration of spatio-temporal similarity compatible.

Furthermore, according to the second example embodiment, by executing the processing (the batch processing) of assigning the tracking ID for identifying the object belonging to the similar object group calculated by the object grouping processing unit 20 to the object, it is possible to detect the frequent person in near real time. For example, by referring to the object tracking information storage unit 60, it is possible to easily detect an object (for example, a person) frequently appearing in a specific place for a specific period. For example, the Top 20 persons who have frequently appeared in an office for the last 7 days from the current can be listed.

Further, according to the second example embodiment, the following effects are obtained.

That is, in the tracking of the object, detection omission or tracking missing occurs due to shielding from the angle of view of the camera by an obstacle or the like. In contrast, according to the second example embodiment, the tracking missing can be improved by the collation of the same object for a wide range of frames and times.

In addition, in the object tracking considering the spatio-temporal similarity, sequential processing in chronological order is required. Therefore, it is not possible to improve the throughput by parallelizing processing in input unit. In contrast, according to the second example embodiment, by classifying the tracking target object into the similar object group, it is possible to parallelly execute the processing of assigning the tracking ID for identifying the object belonging to the similar object group to the object, for each of the similar object groups. As a result, the throughput can be improved. That is, by minimizing a sequential processing portion in chronological order in the entire processing flow, it is possible to improve the throughput by parallelizing most processing.

On the other hand, in the tracking only with non-spatial similarity, erroneous tracking against a spatio-temporal constraint occurs, and the tracking accuracy is degraded. In contrast, according to the second example embodiment, by executing the two-stage processing as described above, it is possible to improve the tracking accuracy of the object appearing in the video.

In the above-described example, the program may be stored using various types of non-transitory computer readable media and supplied to a computer. The non-transitory computer readable media include various types of tangible storage media. Examples of the non-transitory computer readable media include magnetic recording media (for example, flexible disks, magnetic tapes, or hard disk drives), magneto-optical recording media (for example, magneto-optical disks). Other examples of the non-transitory computer readable media include a read only memory (CD-ROM), a CD-R, and a CD-R/W. Yet other examples of the non-transitory computer readable media include semiconductor memory. Examples of the semiconductor memory include a mask ROM, a programmable ROM (PROM), an erasable PROM (EPROM), a flash ROM, and a random access memory (RAM). In addition, the program may be supplied to the computer by various types of transitory computer readable media. Examples of transitory computer readable media include electrical signals, optical signals, and electromagnetic waves. The transitory computer readable media can supply the programs to the computer via a wired communication path such as an electric wire and an optical fiber or a wireless communication path.

Note that the present disclosure is not limited to the above-described example embodiments, and can be appropriately modified without departing from the scope. In addition, the present disclosure may be implemented by appropriately combining the example embodiments.

### REFERENCE SIGNS LIST

1 OBJECT TRACKING PROCESSING APPARATUS
10 OBJECT DETECTION UNIT
20 OBJECT GROUPING PROCESSING UNIT
30 OBJECT FEATURE AMOUNT INFORMATION STORAGE UNIT
40 OBJECT GROUP INFORMATION STORAGE UNIT
50 (50A to 50B) OBJECT TRACKING UNIT
60 OBJECT TRACKING INFORMATION STORAGE UNIT
70 CAMERA
80 PROCESSOR
81 MEMORY
82 STORAGE DEVICE

What is claimed is:

1. An object tracking processing apparatus comprising:
at least one memory storing instructions, and
at least one processor configured to execute the instructions to;
calculate at least one similar object group including at least one object similar to a tracking target object, on the basis of at least a feature amount of the tracking target object; and
assign a tracking ID for identifying an object belonging to the similar object group to the object.

2. The object tracking processing apparatus according to claim 1, further comprising an object group information storage unit configured to store information relevant to the object belonging to the similar object group, wherein the at least one processor is further configured to execute the instructions to
perform batch processing at predetermined intervals, and
the batch processing is processing of acquiring updated information relevant to the object belonging to the similar object group from the object group information storage unit, and assigning the tracking ID for identifying the object belonging to the similar object group to the object, on the basis of the acquired information.

3. The object tracking processing apparatus according to claim 1, wherein the at least one processor is further configured to execute the instructions to
parallelly execute processing of assigning the tracking ID for identifying the object belonging to the similar object group to the object.

4. The object tracking processing apparatus according to claim 1, further comprising an object tracking information storage unit configured to store the tracking ID assigned.

5. The object tracking processing apparatus according to claim 1, wherein the at least one processor is further configured to execute the instructions to
detect the tracking target object in each frame configuring a video and the feature amount of the tracking target object; and
the object tracking processing apparatus further comprising
an object feature amount storage unit configured to store, for each object detected, a position of the object, a detection time of the object, a feature amount of the object, and a group ID assigned to the object,
wherein the at least one processor is further configured to execute the instructions to refer to a part or all of the object feature amount storage unit to calculate at least one similar object group including at least one object similar to the tracking target object, on the basis of at least the feature amount of the tracking target object.

6. An object tracking processing method comprising:
an object grouping processing step of calculating at least one similar object group including at least one object similar to a tracking target object, on the basis of at least a feature amount of the tracking target object; and
an object tracking step of assigning a tracking ID for identifying an object belonging to the similar object group to the object.

7. An object tracking processing method comprising:
detecting a tracking target object in a frame and a feature amount of the tracking target object each time when the frame configuring a video is input;
calculating at least one similar object group including at least one object similar to the tracking target object, on the basis of at least the feature amount of the detected tracking target object, by referring to an object feature amount storage unit;
storing, for the detected tracking target object, a position of the object, a detection time of the object, a feature amount of the object, and a group ID for identifying a group to which the object belongs in the object feature amount storage unit;
storing, for the detected tracking target object, the position of the object, the detection time of the object, and the group ID for identifying the group to which the object belongs in an object group information storage unit; and
executing batch processing of assigning a tracking ID for identifying an object belonging to the similar object group to the object with reference to the object group information storage unit, at predetermined intervals.

8. (canceled)
